(19) United States
(12) Patent Application Publication
(10) Pub. No.: US 2017/0200009 A1
(43) Pub. Date: Jul. 13, 2017

(54) Systems and Methods for Providing an Operating System for a Smart Mirror Device

(71) Applicant: On The Wall, Inc., Oxford, MS (US)

(72) Inventors: Samuel Tucker Bertolet, Oxford, MS (US); Pontus Villehard Andersson, Oxford, MS (US); William Eugene Panlener, II, Oxford, MS (US); Wesley Collin Wright, Oxford, MS (US)

(21) Appl. No.: 15/405,858

(22) Filed: Jan. 13, 2017

Related U.S. Application Data
(60) Provisional application No. 62/278,051, filed on Jan. 13, 2016.

(51) Int. Cl. G06F 21/57; G06F 9/445; H04W 76/02; G06F 9/44

(52) U.S. Cl. CPC G06F 21/575; G06F 9/4406; G06F 8/61; H04W 76/02; G06F 3/04842

(57) ABSTRACT

An system is described herein that comprises an operating system including one or more applications running on computing hardware of a smart mirror device. The one or more applications provide a boot component for controlling low level firmware and boot processes, wherein the boot component loads an initialization process. The one or more applications provide a graphical interface for launching and displaying device applications. The one or more applications provide an authorization component for authorizing installation of the device applications, wherein the authorization component comprises an installation component for installing the device applications. The one or more applications provide a communications interface for establishing communications with a mobile application running on a processor of at least one mobile device.

### RELATED APPLICATIONS

This application claims the benefit of U.S. Application No. 62/278,051, filed Jan. 13, 2016.

### TECHNICAL FIELD

The embodiments described herein generally related to systems, methods, and devices for providing an operating system on a smart mirror device and for interfacing the smart mirror device with third party mobile computing platforms, operating systems and software environments.

### BACKGROUND

A smart mirror device comprises a reflective mirror surface augmented with smart phone functionality. There is a need for developing systems and methods for providing an operating system on a smart mirror device

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows a front view of a smart mirror device including front panel, under an embodiment.

FIG. 2 shows a side view of a smart mirror device, under an embodiment.

FIG. 3 shows a top down view of a smart mirror device, under an embodiment.

FIG. 4 shows a front sensor area of a smart mirror device, under an embodiment.

FIG. 5 show an enlarged view of a smart mirror's device midsection as seen from side view, under an embodiment.

FIG. 6A shows a single USB type-C input, under an embodiment.

FIG. 6B shows a power cord for interfacing with a single USB type-C input, under an embodiment.

FIG. 7 shows the overall layout of the internal computer in spatial format under one embodiment, under an embodiment.

FIG. 8 shows a palette of a smart mirror device, under an embodiment.

FIG. 9A shows a front view of a mini smart mirror device, under an embodiment.

FIG. 9B shows a rear view of a mini smart mirror device, under an embodiment.

FIG. 9C shows a side view of a mini smart mirror device, under an embodiment.

FIG. 9D shows a base of a mini smart mirror device, under an embodiment.

FIG. 9E shows a side wall mounted view of a mini smart mirror device, under an embodiment.

FIG. 10 shows a smart mirror device communicatively coupled with third party devices, under an embodiment.

FIG. 11 shows a software specification of ReflektOS programs in boot order and spatial order.

FIG. 12 provides a schematic representation of ReflektOS, under an embodiment.

### DETAILED DESCRIPTION

The disclosure set forth herein delivers under one embodiment a clear visual and spatial representation of a smart mirror device and corresponding components as further described below. This disclosure encourages the reader to form a mental image of the Myra in operation. This disclosure describes hardware and software specifications for the Myra device and the systems and methods for providing an operating system on such device. However, it should be understood that embodiments of the Myra device are not so limited and that other embodiments may include varying physical sizes, relative dimensions, input/output options, accessories, user interactions, deployable apps, and third-party integrations.

Throughout this disclosure, the following vocabulary may be used to refer to different parts of Myra and its components under an embodiment:
1) Myra (pronounced “My-rah”) refers to a physical smart mirror device and its included hardware, software, and other bundled components.
2) Smart mirror refers to a category of consumer device to which Myra belongs. The term “smart mirror” may be used in this document as a singular noun referring to Myra.
3) Myra-Frame (pronounced “My-rah Frame”) is a name given to any Myra snap-on frame accessories.
4) ReflektOS (pronounced “reflect-ŌS”) is a name given to an operating system bundled with Myra created by On The Wall, Inc. for a series of augmented reality devices. (Note that the Myra smart mirror comprises an augmented reality device). “ReflektOS” may be used to refer to features, individual parts, or actions of such operating system.
5) Facets (pronounced F\check{A}S-\check{e}ts) refers to any bundled and developer-deployed applications (“apps”) for Myra's ReflektOS platform. Facets are specifically the mirror-optimized applications the user interacts with most directly.
6) Reflektor (pronounced reflect-ORE) is the name given to a stack of applications required to run Facets on non-ReflektOS software distributions. Facets are specifically the mirror-optimized applications the user interacts with most directly. In particular, Reflektor is the name given to a collection of applications and frameworks required to provide functionality necessary for Facets. This package is therefore essential to ReflektOS and ReflektOS based devices. However, Reflektor is independent of a given operating system, and may be installed in a variety of environments. Reflektor is intended to be a redistributable component bundled with the OS that could be used separately from the OS; alternative mirror operating systems are major possible use case, but not the only one. Note that an application stack comprises a group of software programs that work together to achieve a common goal. Typical application stacks include closely related software applications that aid in the completion of a certain task. An application stack offers application programs which may help manage tasks. Under an embodiment, a Reflektor application stack provides an environment in which Facets may run on non-ReflektOS software distributions.
This disclosure assumes the following conditions and parameters under an embodiment:
   1) A smart mirror device as described herein may be used in either portrait (tall) or landscape (long) orientations. ReflektOS supports both portrait and landscape orientations but is configured by default to portrait orientation. Unless specifically indicated otherwise, descriptions of the device are given relative to a portrait orientation.
   2) The term “apps” may be used to refer to device applications. can include anything running on the device including background processes.
   3) Free, libre, and open source software (used with respect the systems and methods for providing a smart mirror operating system and environment) include under an embodiment appropriate attribution.

It should be noted that varying embodiments of the disclosure set forth herein may introduce changes in described measurements, computer hardware specifics, and the disclosed application stack.

This documentation is broken into three main sections: Hardware Specifications, Software Specifications, and User Interaction. Each of these are broken into relevant subsections.

### Part 1: Hardware Specification

A description of Myra hardware specifications are provided herein. Of course it should be noted that embodiments are not limited to the disclosed hardware specifications described below and that such specifications may vary including placement and configuration of ribbon cables, power supply, screen size, aspect ratio, ports, accessories, placement of mechanics, etc.

### 1A: Shape and Dimensions

Myra is under one embodiment an all-in-one experience comprising a unibody-style consumer device series. This means that by looking at an assembled Myra, a person may only be able to see I/O ports and holes but not screws. An example design of Myra creates a seamless blend between glass and metal as further described below. The enclosing body, called the “casing” of the device, comprises a single piece of metal. The front panel includes a single, albeit multi-sectioned, sheet of glass.

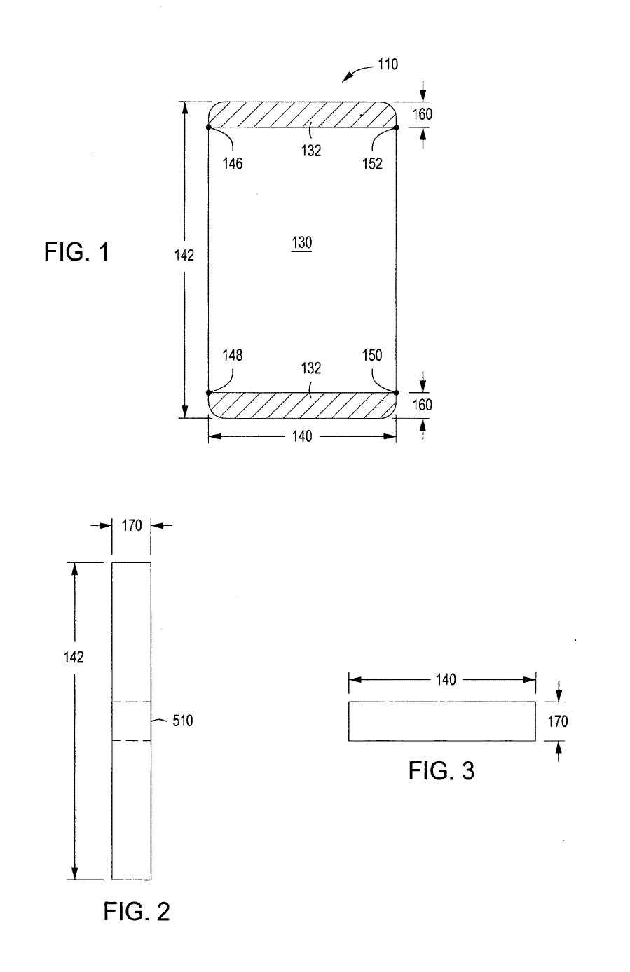

FIG. 1 shows a front view of the Myra device including Myra's front panel 110. This view shows Myra's rounded corners as well as the interactive and reflective portion of the device. The front panel 110 is broken into two key parts under one embodiment: the visible mirror display 130, and an upper/lower bound glass region 132 that hides the device's sensors.

The visible/display part 130 of the front panel extends to the sides of Myra completely, and comprises a diagonal distance between points 148 and 152 of either 23 or 27 inches under an embodiment. The width 140 (length H) comprises a distance between points 148 and 150. The height 142 (length Y) comprises a distance between points 146 and 148. The width 140 and height 142 of the Myra device may form a completely rectangular area. FIG. 1 shows upper and lower bounded, display-free regions 132 of the front panel. The dimension of these regions comprise width 140 (i.e. the width 140 of the display region) and an arbitrary height 160 (length X). At the point where the display height 142 blends with the upper and lower sections at points 146, 148, 150, 152 of the panel, the upper and lower sections 132 immediately begin to curve and thus form the rounded corners of the front view. With the display view 130 combined with the upper and lower regions 132, the total width and height are respectively length H and length Y+2X respectively.

FIG. 2 shows a side view of the Myra device. Unlike the frontal view, the sides are rectangular. This means that the corners of the side view are not rounded. The dimensions of the left and right sides are the same, being of height 142 (Y+2X) and having thickness 170 (Z). FIG. 3 shows a top down view of the Myra device. The top down view shows the dimensions of width 140 (length H) by thickness 170 (width Z). The bottom view of the Myra device is identical to the top view.

The back of the device may be of a uniform metal, with the same angles and dimensions of the frontal view. Unlike the front, there may be no pattern breaks or visible geometric separations on the back of the device.

### 1B: External I/O

Myra features several external sensors, ports, and output devices. Other than the LCD screen, the smart mirror features under one embodiment two microphones, three USB type-C ports, two pushbuttons, three sensors for user detection, and four speakers.

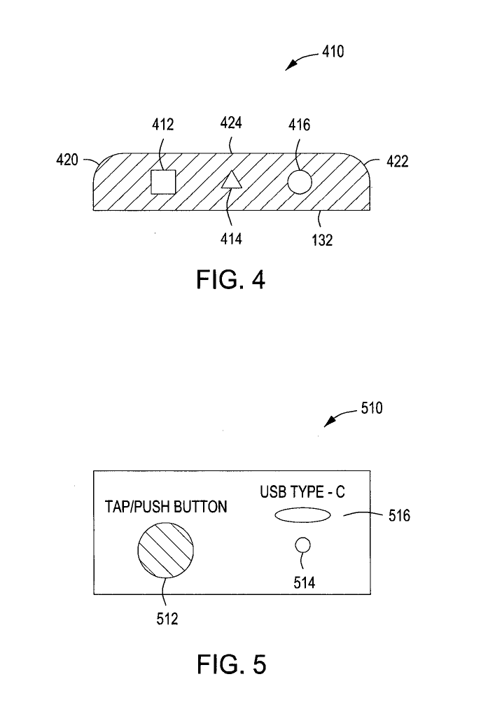

As shown in FIG. 4, the front panel's top section conceals the front sensor area 410. This front section corresponds to section 132 (top) of FIG. 1. Because of the dark glass, the user is not able to notice the small holes where the sensors lie. Under an embodiment, only the top section includes a sensor area. FIG. 4 show an ambient light sensor 412, a motion detector 414, and a camera 416 with motion proximity capability. These sensors may be used to detect a user in the same vicinity as Myra, as well as to detect lighting conditions (light or dark). This interaction is further described below

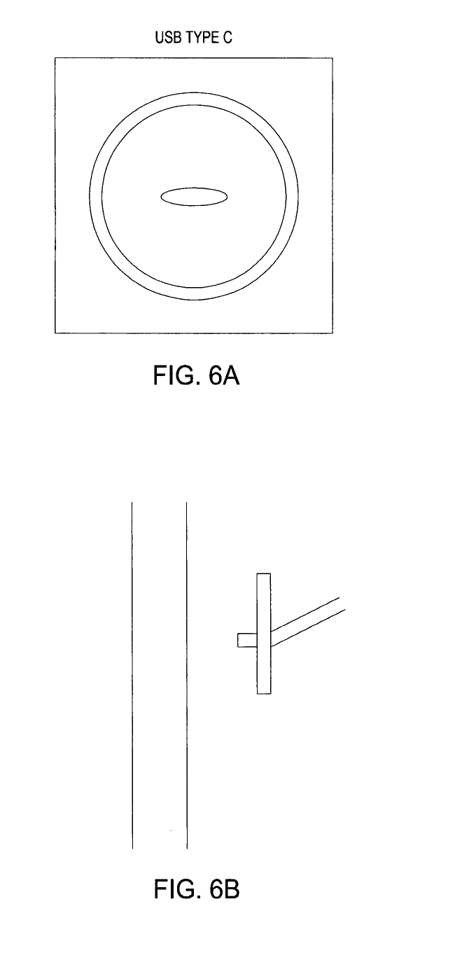

FIG. 5 shows a blowup of midsection area 510 shown in FIG. 2. The enlarged view of the midsection 510 displays a dually sensitive tap/push button 512, microphones 514, and a USB type-C input 516. The dually sensitive button may detect capacitive touch, and act as a physical pushbutton when pressed inwards. The USB type-C connector includes a small hole for microphones below it. These microphones work in tandem to cancel noise and recognize voice input under one embodiment.

FIG. 6A shows a single USB type-C input on the rear midsection of Myra. The rear midsection of Myra may comprise only this single input. This USB-C may be used for power input. A special cord (FIG. 6B) may ship with Myra for this purpose and is designed to fit into a deepened or recessed section of the device.

Speakers may be placed in the four corners of the device. FIG. 4 shows a front view top section of Myra and displays sample locations 420, 422 of speakers. A small grid of holes may cut into the device to allow the passing of sound. Similar speaker configurations may be places in the bottom corners of the device. Further with reference to FIG. 4, note that the metal of the device 424 may be used as the Wi-Fi and Bluetooth connectivity antennas.

### 1C: Internal I/O

Myra's embedded internal computer interfaces with the external I/O, as well as connects to components inside of the smart mirror under one embodiment.

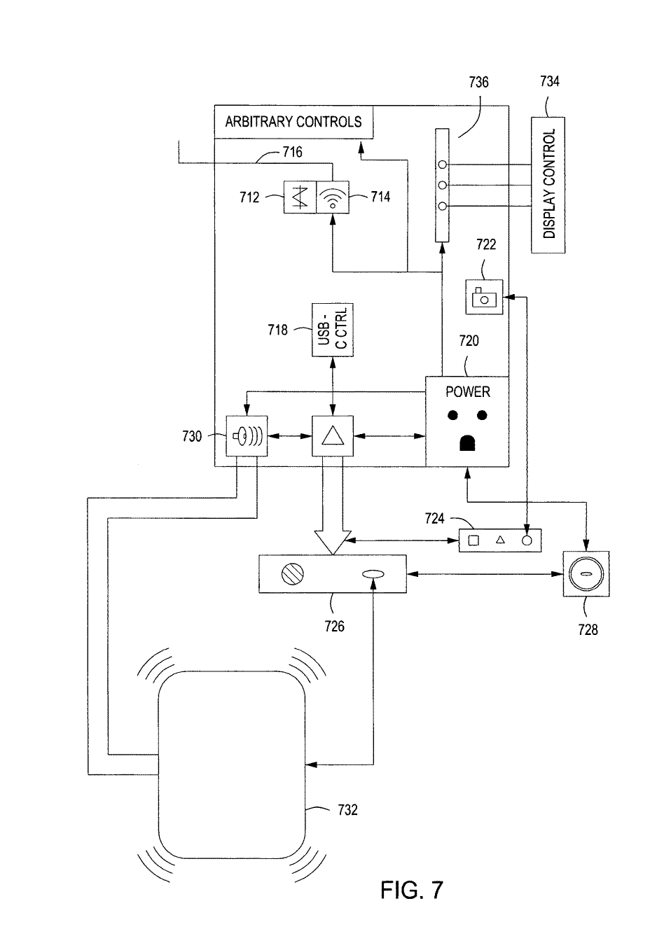

FIG. 7 shows the overall layout of the internal computer in spatial format under one embodiment. This disclosure does not restrict an embodiment to any particular physical layout of the internal components in any particular order. This disclosure presents the manner in which components interface with other components within the Myra hardware and software/firmware environment under one embodiment.

FIG. 7 shows components that are connected to the onboard computer under one embodiment. Although no standard onboard components are shown in this diagram, it is assumed that parts such as Central Processing Unit (CPU), Graphics Processing Units (GPU), flash storage, and RAM are included on the embedded computer of an embodiment.

FIG. 7 shows the IEEE802.11n Wi-Fi and Bluetooth controllers 712, 714 of an embodiment. Signals for these controllers are amplified through an antenna 716 located within the Myra casing. FIG. 7 displays the USB-C controller 718, which is tasked with maintaining core I/O and controlling power output (which comes from an external source; Myra also includes an embedded power supply 720). FIG. 7 displays the camera controller 722 of Myra. Part of Myra's core user experience, as detailed further below is the optional removal of the camera from the device at the hardware level. The camera controller may be connected to the sensor controller at a different internal section 724 of Myra (i.e., front top I/O). These controllers 724, the side-panel I/O 726, the rear power input 728, and the audio controller 730 comprise the arbitrary I/O stack. The audio output feeds to an analog set of speakers 732.

FIG. 7 shows controllers 734 for the device display. Part of the core I/O stack, the display, may be powered by a standard internal output that that is located on the display itself; the internal connection interface 736 used to power the display is an arbitrary industry standard.

### 1D: Build

Due to the nature of a unibody device, Myra is highly compact in internal design under one embodiment.

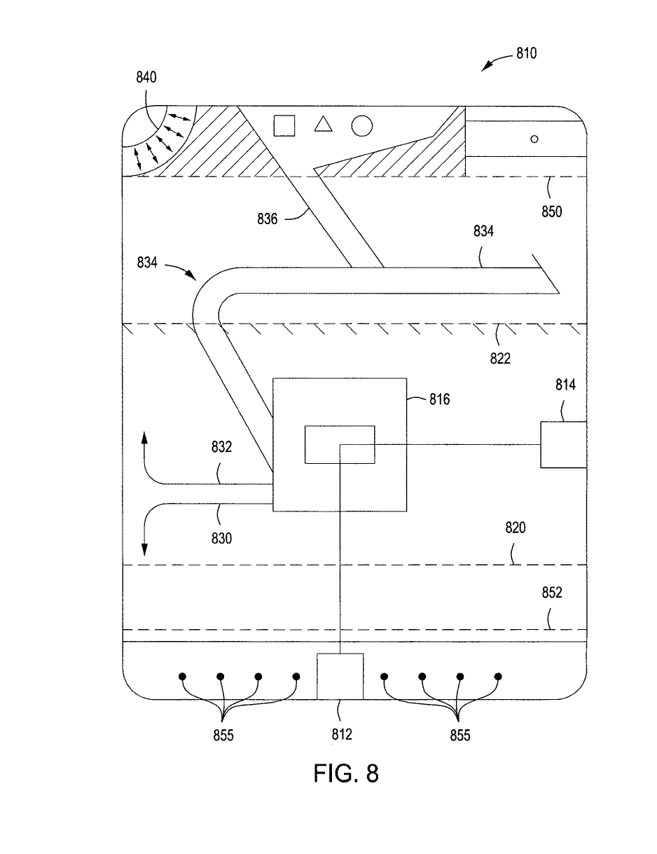

The naked palette 810 of Myra is shown in FIG. 8 under one embodiment as a pre-cut, single sheet of metal. As a first step in placement, the bottom I/O ports 812 and side I/O ports 814 may be placed within the frame. Then, the rear power input and the embedded computer 816 may be placed in the center. The embedded computer may be connected to a rear USB type C power input as shown in FIG. 6A and FIG. 6B. The internal frame comprises a lowered platform between broken lines 820, 822 made for these components. Wiring to the speakers (832) and the antenna (830) are applied under one embodiment before connecting the display ribbon cable (834) and placing in the display. The display takes up a higher, but again predefined area between lines 850 and 852.

The display's ribbon cable 834 splits along the connection to the display and the split cable 836 connects the front sensors.

Once all of these steps are followed, a series of magnets may be placed around the four corners of the inside of Myra. FIG. 8 shows an example of such magnet 840 in the upper left hand corner of the device.

The placing of the glass components is more complicated than a single glass placement. Under one embodiment, washers may be placed on top of the frame's pre-drilled bolt holes 855 (embedded in the casing) at the top and bottom of the device. Next, the one-way mirror may be placed inside Myra, lining up the drilled holes in the glass with the bolt holes in the casing. After this, a thin sheet of pre-shaped metal may be placed on top of the reflective glass at the top and bottom sections of Myra. These pieces have under one embodiment magnetic strips laid across them.

### 1E: Myra-Frame and Accessories

Myra may be bundled with basic, industry-standard accessories. Power chords and setup materials are provided under one embodiment.

However, On The Wall, Inc. provides under one embodiment a customizable class of accessory for Myra; the Myra-Frame. The Myra-Frame is a specially-designed snap-on frame for Myra used to blend Myra with its environment. This overview may be available in varying shapes, sizes and designs to accommodate the varying dimensions of Myra devices. Such frame may be with magnetic force to Myra's corner magnets (FIG. 4, 420, 422; FIG. 8, 840). Small, hidden holes for the front I/O (FIG. 4, 412, 414, 416) and side I/O (FIG. 2, FIG. 5; 510) are cut out of the frame for user interaction; especially for the side I/O button.

### Section 1F: Myra Mini

Myra may also come in different shapes and sizes, with similar but more niche use cases. The above features may be iterated upon, selected for removal, or changed in future revisions. One such example is the second edition of Myra, the Myra mini.

Myra mini uses ReflektOS to create a portable “makeup mirror” experience for the user. It competes with other small, non-handheld makeup mirrors.

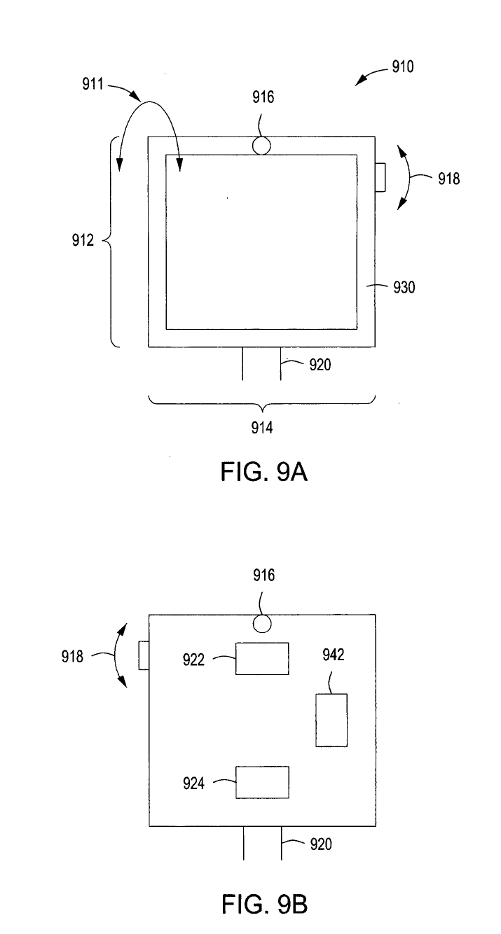

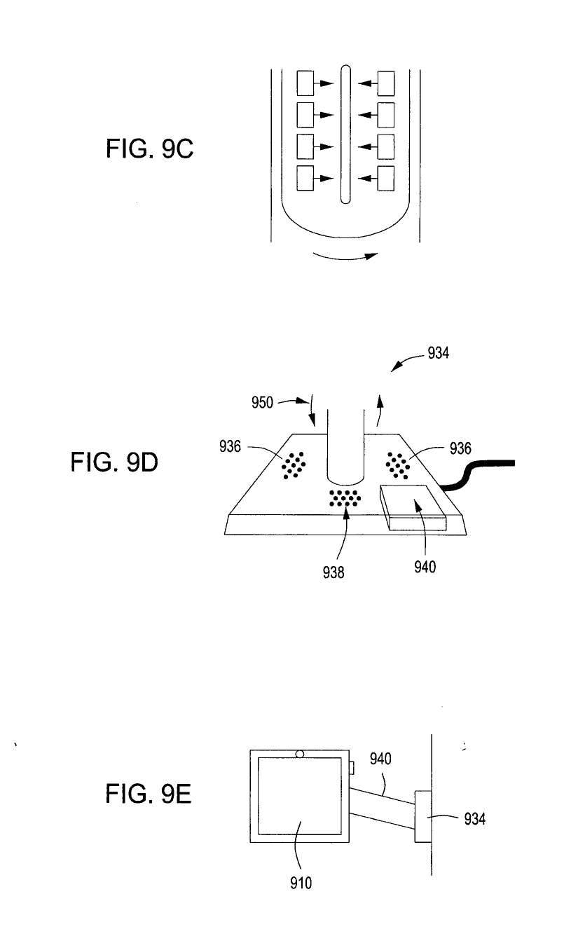

FIG. 9A shows a front view of the Myra Mini device 910. FIG. 9A shows the device's magic mirror LCD display and two-way mirror stack. Two way mirror is a nickname given to glass that functions as a mirror on either side, as opposed to a one-way mirror, i.e. a piece of glass functions as mirror on one side. “Stack” in this case means a certain configuration of a LCD stacked upon a mirror-glass and a mount. The glass may comprise anti-fog glass. Anti-scratch foam may be placed between glass and LCD. FIG. 9A shows the height 912 (length x) and width 914 (length y) of the device. There is a small area at the top for sensors, just like in the original Myra. As an example, the device of FIG. 9A displays a camera 916. There is a rotary switch 918 located on the right side of the device. It can be rotated and tapped to interact with apps. Around the border of the device, Myra Mini's screen is surrounded by a layered set of LED diffuser film 930, used to obscure double-wrapped LED lights around the interior and exterior of the device shell. The device is mounted on stand 920.

FIG. 9B displays the back of the Myra mini device. FIG. 9B shows placement of the rotary switch 918, camera 916, embedded computer 922 (within device case), display LCD controller 924 (within device case), arbitrary controllers 942 (within device case). Again, the device is mounted on stand 920.

FIG. 9C shows a side view of the device. In particular, FIG. 9C shows that the LED diffuser film wraps around the side of the device to provide an LED diffuser film layer around the front and back peripheral border of the device.

FIG. 9D shows a base 934 of the device. FIG. 9D shows speakers 936, microphone 938, and power supply 940.

Note with reference to FIG. 9A that the device may tilt 911 forwards and backwards. With reference to FIG. 9D, it is shown that the device may rotate 950 about the base 934. The device may also be adjusted upward and downward along the base.

FIG. 9E show as a wall mounted version of the device. Device 910 is mounted to base 934 using arm 940.

### Part 2: Software Spec

This software specification of an embodiment covers custom and redistributed and in-house programs in boot order and spatial order (after Subsection 2D). Spatial order in this context means that the order is not in chronological boot order (after section 2D). Sections after this point are processes that all generally start around the same time and are launched on-demand. Therefore, they are in the same “space”. Program categories begin with the lowest level of system software and end with the halting of userland.

ReflektOS has three target deliverables: one open-source, freely available operating system; one closed-source fork of said operating system, in charge of handling encrypted and proprietary media formats¹; and one portable application that may run in various operating system environments (Windows™/Apple™/Linux™) that simulates what ReflektOS may appear like to a user. ¹ This may refer to hypothetical partnerships between On The Wall and other companies which may provide proprietary playback abilities

If a user chooses to install a Reflektor instance inside of an existing software configuration/operating system, only Sections 2F-2O apply; Reflektor does not attempt to operate as a complete operating system, but rather a software package created by On The Wall, Inc. to run facets in a non-reflektOS environment.

### 2A: Low-Level Firmware

ReflektOS's low-level firmware booting process comprises several components which handle loading the device kernel. It is the most standardized part of the operating system, and follows many industry-standard booting procedures. At this point, each component is powered on and probed for basic electrical functionality. If system integrity checks of essential components are malfunctioning, the device will either power off; or display a warning regarding a failed non-essential component (status message displayed as defined in section 2E). This refers to an industry standard POST-like self test. Any computer used or built will have a manufacturer created check system.

At the time of power initialization, the primary functions of the on-board computer are disabled. A basic power functionality powers on the GPU, which may execute the early stage ROM firmware, stored on the on-board system on a chip (SoC). The bootloader then begins to read from the on-board flash storage. The multi-stage bootloader may then be loaded into RAM and executed.

The onboard firmware is under an embodiment preconfigured to run a standard Power On Self-Test (POST) before initializing component hardware. In the event of a hardware response failure, at any time during the boot process, an error splash screen may be displayed. After the firmware is deployed into the cache, a splash screen is loaded and the Linux kernel will begin to initialize.

Myra's on-board computer follows a pattern of industry standard booting procedures, which may occur on any number of on-board computers, depending on the model or revision of Myra. Myra's ReflektOS begins to load after initialization of basic power functions provided by said on-board computer.

Myra's low-level firmware will initialize any specialty devices during the appropriate boot time execution. The boot process will continue as normal until the kernel of the device is initially loaded.

### 2B: Linux Kernel Image

ReflektOS may use the latest Linux kernel release that is provided by kernel.org, i.e. a specialized Linux kernel image. Specialized drivers, including those developed by On The Wall, Inc. for onboard and external I/O may be used and initialized during the boot process to accommodate special I/O and software features of the device. The Linux kernel requires very little modification for specialization of customized hardware, as the only changes that may be applied are the customized kernel extensions for hardware. The kernel used in Myra may require special modification to load objects that On The Wall, Inc. have built in order to properly utilize special functions of Myra. Myra may also need to load third-party, proprietary firmware into the Kernel. For example, the Rotary Switch used to control page interaction will be probed and launched at boot. Another example: microphone kernel drivers used in Myra may be probed to check if the microphones are properly receiving. If they fail, we may execute fallback measure mentioned elsewhere in the document.

After the bootloader completes initialization, Linux's boot process begins. The kernel runs several tests to verify the integrity of the onboard hardware, and may abort booting following a critical hardware status message. Critical hardware status message may include disk corruption, driver crashes, etc.

After initial low-level booting has completed, industry standard procedures are taken in order to guarantee that the integrity of the software and hardware are maintained. In case of a warranty clause with devices, said procedures will always be taken in order to report to the user any critical errors outstanding of the device. If any user-induced modifications have been made to the hardware or software, the user will be warned via a notice upon initialization of the Graphical Interface (Section 2E).

### 2C: Userland Init

ReflektOS of an embodiment uses a customized flavor of the Debian GNU+Linux software distribution. ReflektOS is built using a forked Linux distribution. The purpose of this is to guarantee system stability and industry-standard compatibility as ReflektOS grows and the developer community becomes more active. Debian packages systemd as the userland controller for all processes. ReflektOS may use standardized systemd startup scripts to initialize system services post-kernel initialization. These services include for example WiFi or Bluetooth stacks, sound system stacks, graphics stacks, etc. . . . Upon loading, systemd verifies the startup services' integrity and controls the initialization of ReflektOS's external communication software. Systemd may be tasked with monitoring the status of all running system software, as well as individual Facets. Upon failure of a service, systemd restarts the appropriate process under an embodiment, as well as halt any processes that cause the system to hang (and consequentially damage system integrity). ReflektOS will utilize a standard initialization process that begins after the loading of the low-level firmware, such as systemd or sysvinit, and ends with the first “UNIX userland” process becoming active.

It is implied and understood that between the loading of firmware and the loading of userland, that the provided software packages that ReflektOS is built upon will provide a method for verifying integrity or system services and loading required booting procedures.

### 2D: System Services

ReflektOS includes under an embodiment most default services that come with many flavors of Linux. Upon successful loading of userland, the X.org window server may launch to the onboard display. At this point, a custom window manager is launched from X.org.

ReflektOS requires no user authentication under an embodiment, and a dedicated UNIX-style user account may be logged into a session. From here, two simultaneous processes may begin: ReflektOS loads the default background processes from Debian, while the custom Desktop Environment is displayed, initializing the Facets.

ReflektOS provides a subset of common Linux system services as well its own specialized services. These packages are categorized by supporting the device from the background rather than by providing a direct end-user interface. The packages support configuration and interoperability with other devices, services, and applications, both those provided by On The Wall, Inc. and those provided by third parties.

### 2E: Interface Startup

Under one embodiment, ReflektOS uses a quiet boot process, meaning that a user sees no detailed boot information, but instead a graphical splash screen (a static or animated logo or picture). From the splash screen, the user is directly greeted with the main graphical interface. By this time, the user-configured network settings are initialized and ReflektOS will connect to relevant Bluetooth and Wi-Fi capable devices and networks, respectively.

Once the Desktop Environment is loaded under this embodiment, the user's last Facet configuration and placement are loaded. At this point, the user is free to interact and use the features of ReflektOS.

By the time the main interface is presented, ReflektOS has already loaded relevant configuration and application states, including launching any relevant services, facets, or other applications.

### 2F: Security Environment

ReflektOS uses Secure Socket Layer (SSL) for all communication protocols under an embodiment. Devices compatible with ReflektOS must support SSL or Transport Layer Security (TLS). Upon failure of loading the relevant security protocols, some system services may be unavailable. All encrypted data may use RSA-2048 or stronger protocols.

On The Wall, Inc. owns a Certificate Authority pre-installed on ReflektOS. This server is used under an embodiment to approve Facet scripts, generate dpkg keys, and communicate with every Myra. This is used for secure authentication of packages and programs. Before updates will install, facets opened, or files accessed, a code signing certificate granted by On The Wall, Inc. is used to verify integrity and authenticity of code.

The file system of ReflektOS is under one embodiment not encrypted, but most system directories are. In addition, standard Linux practices are used to make sure that on-board firmware is mounted in an inaccessible directory in order to ensure system integrity.

All firmware updates for Myra installed through ReflektOS may be signed by both hardware manufacturers and On The Wall, Inc. Manufacturers of devices like embedded wifi, as well as in-house driver updates from On The Wall will both be signed. Under one embodiment authentication comprises an MD5 hash verification. In the event of any key mismatch, the system will not install software.

The user may choose to require a password, in which case an overlay will be displayed before any Facets upon UNIX login time. With this setting turned on, all directories are under an embodiment encrypted with the user's password. The user uses the accompanying app to type in the password and disable the initial encryption. This process is documented in Section 3.

ReflektOS follows standard security, encryption, and hardened communication measures provided by the software distribution it is built upon; and expanded by On The Wall, Inc. Many, but not all, of these security measures are defined by popular security specification consortiums. These varying security measures prevent unwanted exfiltration or corruption of user and system data. This is accomplished using third-party software and best security practices. On The Wall, Inc. may also incorporate self-made security-focused software and novel security practices. These may include but are not limited to software signing, encrypted methods of software distribution, localized data encryption, and limiting the scope of data that Facets may access (Sandboxing).

Upon installation, third-party Facets are under an embodiment installed to individualized, sandboxed environments. A sandbox typically provides a tightly controlled set of resources for third-party programs to run in, such as scratch space on disk and memory with the intent of limiting the potential impact of malicious or malfunction Facets. Additional measures will be taken to prevent the creation or deployment of malicious software onto any ReflektOS environment. These measures may include but are not limited to: filesystem segregation, hypervisor memory management, single-executable runtime enforcement, “dry-run” installation simulation, and explicit file manifest requirements. Network access, the ability to inspect the host system or read from input devices are usually disallowed or heavily restricted. Facet instances are sandboxed in directory structure, file ownership, and API access. Sandboxed Facets of an embodiment communicate through ReflektOS's networking Python API rather than have unfiltered internet access.

In order to be executed, a Facet file of an embodiment must contain an approved certificate, be installed through the official ReflektOS repository, and contain one main script. This helps ensure that each Facet is only a single instance. Python's garbage collection memory management works efficiently under one embodiment to halt a script attempting to escalate past its allowed privileges.

Before installing a requested Facet, dpkg is customized to check the file structure and verify that the Facet contains the necessary security structure.

Under one embodiment, a lesser privileged UNIX user is generated and designated to each installed Facet in order to ensure that Facets cannot interface outside of their regular permission level without explicit user and API approval process is allocated for each running Facet. Some sensitive ReflektOS APIs used by a Facet may present user authorization requests at execution time. Users are free to adjust the level of security the sandboxing technology enforces.

The sandbox environment is designed to limit processes such that they can only access system features and resources essential to their execution. Due to the nature of security, the design of the sandboxing environment must remain relatively fluid: new vulnerabilities discovered within the environment may require fundamental changes in sandbox design. However, techniques potentially used by the sandbox include: filesystem virtualization, such that processes may only view or edit files which they own or which are essential for execution; interprocess communication whitelisting, wherein processes may only access certain system services when granted explicit permission by the user; and various levels of memory and child process protection, preventing processes from marking arbitrary memory as executable or spawning child processes.

### 2G: Graphical Interface

The desktop environment comprises the wrapper for facets, and is charged with controlling user input, status codes, displaying relevant I/O status messages.

The Desktop Environment's visual framework is a completely in-house visual builder framework. The framework is a system of pre bundled developer software used for designing alpha-channel elements on top of X. Visual elements may be white or clear against a black background. In this way, the DE may be similar to most in that it uses a regular desktop layout, but includes no boundary features (task bar, launcher, etc.). The DE under such embodiment launches Facets directly.

As a wrapper, it may display a grid-like structure across Myra's display. Facets are then placed along this grid, and measured in grid units. It is customized so that all of regular Desktop Environment features (power control and other system functions) are displayed as facets along the same grid. Grid objects are under an embodiment interfaced in the style of a Tiling Window Manager; Facet grid structures are alpha-channel windows with no borders.

As detailed later in Section 2, Facets are under one embodiment Python 3 scripts. Due to this, the DE is not tasked with starting applications, but rather launching Python instances and translating these objects to the window manager. The DE primarily serves as an integral middleman between deeper system software and the rest of ReflektOS; system-level functions are interacted with just like Facets. Bundled and standard unix software behaves the same way as facets; each instance of a facet is controlled by systemd. Therefore, the linux kernel has control over what programs are launched and what programs are closed. An example would be that a “shutdown” facet could trigger a system-level function because facets behave like windowed applications on a desktop.

The graphical interface is a set of components that are loaded after silent system services have successfully been initialized (defined in Section 2E). These components include but are not limited to a notification display service, launcher, display manager, idle screen, wallpaper, lock screen, interactive layout of Facets, and an interface for modifying settings of a ReflektOS device. Depending on the physical size of the ReflektOS device or Myra model, the method of displaying the above and other graphical assets may differ. The graphical environment communicates with the system software to manage the Facet application state, depending on user input. The graphical interface is also responsible for, but not exclusively limited to, the placement and appearance of Facets.

The behavior and appearance of the graphical environment is largely implemented by the Reflektor package; however, individual installations of Reflektor or ReflektOS may use differing technologies in order to support the graphical environment. For instance, some Linux-based distributions of Reflektor may use the X windowing system for display.

### 2H: Interconnectivity Environment

ReflektOS communicates with external applications via either Bluetooth 4.0+ standards, or over Wi-Fi to compatible devices under an embodiment. ReflektOS implements WiFi a technology for wireless local area networking with devices based on the IEEE 802.11 standards. ReflektOS works as a server under one embodiment. A standard (configurable, see Section 3) TCP signal is opened over the network that client apps are able to connect to.

ReflektOS uses under one embodiment standard and native API frameworks for audio playback, interfacing, and network communication.

The API framework we are referring to is non-specific; if a user hooks up a phone to Myra with Bluetooth or USB, it doesn't make a difference because ReflektOS adheres to all of the playback and communication guidelines from the Bluetooth consortium, Apple, Google, and even Microsoft. It seamlessly integrates with all major mobile operating systems. It is able to send pictures taken with the onboard camera to accompanying apps. ReflektOS uses the latest home integration APIs for devices. As one example, Myra connects to Apple HomeKit and Google i/o.

Audio and video data transfer conform under one embodiment to API capabilities. As one example, transferring files relies on adhering to an API spec sheet from Apple. If we want the iPhone to be able to play music to Myra through USB, we have to follow the API guidelines. Analogously, ReflektOS implements audio and video data transfer APIs for Android and Microsoft operating systems and devices.

All bundled features of ReflektOS may be accessed via either Bluetooth or Wi-Fi, with the exception being some audio playback. Without capable Bluetooth, ReflektOS utilizes physical connections to play audio via USB API or auxiliary input.

ReflektOS includes a custom API used for apps on third-party devices to change settings of both the system and individual Facets. This is a private API that may interface with XML and JSON formats. For example, a user's phone may be paired with Myra. For a user to use the Myra app on the phone to change settings: ReflektOS sends a j son of the current settings, the app parses the information, settings are changed by the user, and a json is sent back to ReflektOS.

ReflektOS supports common means of interconnectivity such as communication over wireless networks and interaction with Internet services. ReflektOS provides additional, specialized packages which may include support for configuration and interoperability with third-party platforms over the network, particularly applications or packages designed for administering ReflektOS installations. ReflektOS's interconnectivity abilities also contain, but are not limited to the following transmission applications: the ability to broadcast, receive, and record audio and video signals over a variety of hardware; communicate said data with third-party services; utilize remote proprietary and third-party remote control software; and receive and display information gathered from other wireless-capable devices (provided compatible hardware is available on both the ReflektOS and third-party device.)

### 2I: Hardware Communication Environment

Apps for third-party devices and Facets may use standard Linux methods of communicating with onboard system hardware and user devices. Although built-in facets and official applications may use the on-board microphone and camera, third-party facets are under one embodiment installed and run as a less privileged UNIX user process as a security measure. As detailed in Section 3, a user may choose what data ReflektOS and all of its features have access to.

System level software may use built-in sensors to maximize user experience. All firmware is system level software, but all system level software is not firmware. Firmware is distinguished from other software in that it is relocated to storage locations on hardware components to serve as a runtime program for that hardware component. An example of firmware would be a program that accepts commands to control radio gain and input/output buffers. This program would be considered firmware at the point that it was moved into memory of a wireless radio. This would be distinguished from non-firmware, system level software not loaded on the wireless radio such as a driver that is responsible for loading firmware on the wireless radio or interacting with the firmware. Neither the firmware nor the driver used in this example would be considered a service. All services will be system level software, but not all system level software will be services. Services are high level processes that run in the background but are typically not directly visible to the user. Examples of services include web servers, printing servers, and system logging. In addition to collecting data from sensors, system level software may control or interact with quite literally anything. Rules are written for system level software to limit what exactly each piece of software is allowed to control or interact with.

System software is under an embodiment used to communicate with these sensors, as well as handling root-level actions required by device firmware. For example, root level actions may include starting and stopping services, modifying system level software, shutting down the system, modifying rules dictating permissions for system level software, etc. Only software explicitly specified by On The Wall, Inc. will be able to utilize these escalated privileges. escalated privileges refers to the ability of software to access any device or software feature without encumbrance; these could include sensor access, but not in the same sense in which regular applications would access them. “Escalated privileges” refers to bypassing security measures out of necessity. Furthermore, only firmware may be able to control I/O functions directly. Developers are under one embodiment able to request access to all of Myra's a ReflektOS device's hardware through ReflektOS's API, which allows interfacing through system software. In the case of Reflektor-only installations, or non-Myra (open source) ReflektOS installations, privileged access is granted to all Facets by default. Facets are under an embodiment not able to execute hardware modifications or access regular Linux APIs lower level system interfaces.

On The Wall, Inc. takes the handling of sensitive user data very seriously. No personal information except for preferences and logged in accounts are stored on the device under an embodiment, but instead on paired third-party device apps, official or user-authorized companion applications. Encryption is a process handled by low-level software. Advanced settings may be used to disable use of the camera, microphones, and/or sensors. Because Facets are unable to communicate with system drivers under an embodiment, only the hardware communication layer may re-enable these features. Note that with the user's explicit permission, audio, video, or other personal data is sent over a network in order to be transcribed. For more info, see Section 3.

### 2J: Software Packaging/Installation Environment

ReflektOS uses Debian's dpkg and apt-get installation system. Both system software and Facets are packaged in .deb format under an embodiment. Due to technical requirements, apps on third-party devices may not be able to download Facets. To clarify, this is referring to the strict rules from apple about no feature duplication—Apps cannot retrieve a facet and deploy this facet to the Myra. Instead, installing facets from the app just sends a command to ReflektOS to retrieve the certain app. This is done so that no executable data is downloaded to the phone. Instead, applications are retrieved directly by ReflektOS via a custom Debian format Repository. Due to the nature of software packaging, the repository is located in an advanced level cloud environment under an embodiment. As industry standard practice, packages cannot be installed without a verification cryptographic summary of a package.

Upon selection of either system firmware updates or third-party facets, the apt-get library is under an embodiment called and a remote package fetched. The dpkg installation system also provides a standard library for upgrade and removal of software. This functionality is under an embodiment accessible by all apps on third-party devices.

The list of available Facets are under an embodiment shown through the Third-party device's Myra app, and the apps will listen for a unique URL handler (Myra://) for triggering a Facet install.

ReflektOS provides mechanisms for installing, updating, and removing non-essential software, including third-party software. Measures are taken for verifying and authenticating software using techniques such as code-signing. Integration with other system services is provided to facilitate administration and configuration of installed packages, potentially over networks or from other software or hardware.

In addition to Reflektor's package management, ReflektOS may use additional packages, in order to update and maintain itself. This is separate from the functionality provided by Reflektor described above; ReflektOS's package management facilities handle system updates rather than facet and third-party updates and installations. These package management solutions may be sourced from the base operating system; candidate solutions could include Debian's “dpkg” program or FreeBSD's “ports” system.

### 2K: Sandbox Environment

See section 2F for a description of sandboxing.

### 2L: Facets

Facets are the primary applications and the core feature of ReflektOS. Facets are under an embodiment single-instanced, stylized Python 3 instances. They may interface with the internet and may display relevant notification to the user via Myra's a ReflektOS device's onboard display. Facets are not necessarily programs, but a series of commands given to the Desktop Environment in order to display a unique tile.

Because Facets of an embodiment are written in Python, developers are able to build applications that already interface with many third-party services. All of Python's features may be completely unmodified with the exception being the library to write the main window of a Facet. A custom abstract library may be used to turn python scripts into facets. The custom abstract library comprises a custom window kit library for python.

Upon execution, a Facet drawn to the window manager requests a grid size. Then, the Python instance libraries are loaded and dynamic vector graphics are displayed on screen. Due to the customizable nature of a window manager, Facet interfaces are allowed to change in real-time; nothing about a Facet is static. If the user desires, multiple instances of one Facet can be created.

Under one embodiment, a packaging utility will be provided to developers in order to “compile” a Facet for submission into the official ReflektOS list.

The definition of a Facet is very broad; they are any series of applications that display on a smart mirror. Independent of function, an augmented reality device that displays information, receives input, or executes a given function within the boundaries of said display is a Facet. The definition is as broad as any size software stack needed to accomplish said function. If applications are formatted to work with an augmented reality operating system, or vice versa, these applications are Facets.

Under one embodiment, Facets are applications specifically built for the Reflektor stack; they conform to Reflektor standards for configuration, resource management, and user interaction. This conformance and standardization allows for Reflektor to install, configure, manage, and display Facets uniformly. The important categorization to understand is that there are two types of applications on this system: Facets, and non-facets. Facets are not specific language apps, or specific type apps, but they are apps that are built for the user's smart mirror experience. This is easily understood by titling applications vs. Facets; “a background service could be utilized by the Weather Facet to show weather to the user and a Facebook API daemon could be used by the Facebook Facet to display a timeline to the user. Facets will always be titled as such when possible, i.e. The Facet Store and developers will always refer to a Facet as The “______ ” Facet. Under this embodiment, Facets are not limited to any single programming language.

It is therefore understood that Facets may be created/implemented using programming languages other than those described herein.

As stated in section 2O, Facets may be thought of as applications designed for Reflektor. This includes conforming to standards established by Reflektor for application packaging, such as inclusion and formatting of manifest files, as well as using standard APIs specified by Reflektor. By following these conventions, Facets are able to take advantage of many of the security, UI, and interconnectivity features of Reflektor.

### 2M: Bundled Software

ReflektOS includes a small set of default Facets for users. These provide under an embodiment basic example functionality and serve as a tutorial for use of ReflektOS. Facets for stock markets, sticky notes, social networks, and similar basic applications may be included in the default set. These may be disabled or completely uninstalled if desired.

As previously stated, ReflektOS is under one embodiment based on Debian GNU+Linux. Command line utilities and included libraries are used for almost every major part of the operating system. Although hundreds of programs are used, some require explicit attribution in order to be used. GNUTLS, ffmpeg, libaac, programs from the Apache Foundation, and libraries from the Linux Foundation may be used in ReflektOS through proper attribution.

ReflektOS also utilizes under one embodiment several third-party services for maximized user experience. These services are enabled by default, but can be disabled. Google Cloud Compute™ and Amazon Web Services™ provide multiple advanced features of ReflektOS. For example, easy software hosting and voice communication are provided by Google™ and Amazon™ respectively. Data from both of Myra's microphones are sent to Amazon for analysis of voice and background noise.

On The Wall, Inc. may allow users to change or modify any part of the Operating System with the exception of private API keys. It should be explicitly stated that ReflektOS under one embodiment secures third-party APIs and these integrated features may be removed, but not tampered with.

On The Wall, Inc. may include default applications (typically, but not exclusively, Facets) to ensure a high-quality ReflektOS default user experience. Example software may include, but is not limited to, weather, calendaring, video streaming, and note display widgets, as well as software for displaying paired device notifications. These applications may be licensed from third-party vendors; all proprietary, third-party assets belong to the respective licensors. On The Wall, Inc. may include packages from the software stack it was derived from. This software may be modified to accommodate a given ReflektOS-powered device. Implementations of third-party protocols are clearly labeled, and On The Wall, Inc. does not lay claim to previously copyrighted, albeit redistributable, information. Furthermore, third-party features are not forced onto the user, in compliance with standard software distribution policy. In order to follow legal regulation, users of Myra must acknowledge and agree to any relevant licensing terms for bundled third-party intellectual property.

On The Wall, Inc. reserves the right to change third-party software bundled with ReflektOS without prior warning.

### 2N: Power Functionality

ReflektOS aims to be energy conservative. When ReflektOS is inactive and the sensors detect no activity from the user, power to Myra's display is turned off under an embodiment, and system services are halted to conserve energy. The side buttons, as well as network protocols, may be used to power off or sleep ReflektOS. If ReflektOS determines that the device is not in active use, whether via explicit user input, via timeout, or via hardware sensors, it may enter a lower-power “sleep” state, potentially disabling the screen as well as any unnecessary system services.

When the power off functionality is triggered, ReflektOS may proceed in standard Linux halt operations. Under such embodiment, Python is halted, the UNIX user is logged out, and systemd shuts down userland. When the device is powered off, it cannot be used until the physical buttons are used to trigger another boot. ReflektOS also supports a true power-off functionality, in which all system services and user applications are closed, the operating system itself halts, and the device disables power consumption.

In the case that a ReflektOS-powered device uses a battery, a customizable power-use profile is able to disables features depending on the availability of remaining power in the battery (Section 3D).

### 2O: Reflektor

Reflektor is a collection of applications and services responsible for implementing the essential features of the Myra/ReflektOS experience, specifically those involving Facets and some other third-party software. Reflektor implements security, interconnectivity, and UI features from which Facets may be built; Facets may be thought of as applications designed for Reflektor, as described in section 2L. Reflektor additionally provides services for the installation, removal, and configuration of Facets.

Reflektor is considered separate from the ReflektOS distribution, and is designed to be installable and reusable on other, potentially third-party, operating systems and devices. ReflektOS may be thought of as providing a convenient, pre-configured, and well-optimized distribution centered around Reflektor.

Reflektor is responsible for providing the sandboxing and security features described in section 2F and the high-level components of the Graphical Interface as described in section 2G, as well as exposing the interconnectivity features described in section 2H to Facet developers.

### Part 3: User Interaction

Myra is a user-centered experience. Under an embodiment, ReflektOS is an operating system designed for a mirror, and the UX user experience is created specifically to be hassle free and easy-to-operate. Part 3 details the user experience in no particular order.

### 3A: Power-On and Initial Setup

When Myra a ReflektOS device is powered on, a splash screen of an embodiment is displayed. In the case of a Reflektor instance simulating a ReflektOS install, it is possible that an alternate boot procedure, or potentially none, is executed in order to optimize user experience. If it is the first time Myra a ReflektOS device is being powered on, or a system reset of any kind has been triggered requested, ReflektOS may initiate trigger the first-time setup. When a ReflektOS device is powered on, a splash screen of an embodiment is displayed. In the case of a Reflektor instance simulating a ReflektOS install, it is possible that an alternate boot procedure, or potentially none, is executed in order to optimize user experience. If it is the first time a ReflektOS device is being powered on, or a system reset has been requested, ReflektOS may initiate first-time setup.

The first time setup presents under one embodiment a welcome screen with indicative Wi-Fi and Bluetooth icons following. ReflektOS broadcasts a Bluetooth server and infrastructure IEEE802.11 Wi-Fi network named “Myra” which may accept any device connection. The first-time setup process can include mechanisms for allowing the user to connect to the device from a separate device or service, potentially by broadcasting availability to other devices over a series of wireless signals and standard protocols such as Wi-Fi or Bluetooth. The graphical interface may display icons, text, or other symbols to the User to indicate the availability of these mechanisms and any additional instructions needed for connection. This setup may change or be removed over time to enhance user experience.

Upon connecting to either of the networks and launching the Myra app, the user sees under one embodiment the app trigger setup mode. This mode allows the user to connect ReflektOS to a Wi-Fi network, register names, and pair minor OS features (third-party services logins, passcode selection, etc.) Once a first-time setup mechanism has been engaged, it may be used to configure the device and its miscellaneous features, possibly including but not limited to Wi-Fi network access, first- and third-party internet accounts, power profile behavior, and Facet preferences. Once the first-time setup procedure is completed, the device may resume the relevant portion of the boot process as described in sections 2A through 2E. A normal power on shows the splash screen, and quickly loads all of the Facets that the user has placed across Myra's display. If this first time setup is not optimal for a user, additional accessibility and usability options will be offered to a user in order to accommodate for varying user needs or environments.

### 3B: Environment Interaction

Under one embodiment, ReflektOS uses Myra's device sensors to adjust to the environment and conserve power and enact system configurations, including power consumption, user interface, and interconnectivity preferences. The Facets are hidden until the user launches them with Myra's accompanying mobile smartphone app, touches the side buttons of Myra, or the user approaches the device.

As an example, a ReflektOS service could use light sensor data to automatically adjust display brightness in order to conserve energy while ensuring legibility. Other system services, and potentially third-party applications or Facets, may elect to, or be configured to, respond to sensor data as appropriate.

Power to the motion and light sensors are always enabled during the visually muted standby mode. When a user triggers the motion sensor, the Facets are quickly activated. As described in 2N, ReflektOS may enter a “sleep” mode, either upon explicit request or when it has been determined that the system is not in active use. ReflektOS installations may be configured to use sensor data to make this determination. While in sleep mode, ReflektOS may also elect or be configured to maintain sensor activity. ReflektOS may allow system services or applications to continue to use sensor data as stated above even while in sleep mode; for example, a service could end sleep mode in response to light or motion data.

In order to remain pleasant to interact with, brightness of the screen may be set automatically depending on the brightness of the surrounding area. This brightness setting may be changed by the user if desired.

When the sensors' data shows that no interaction has occurred within a significant amount of time, ReflektOS triggers under an embodiment an extremely low power setting similar to a full power off. This hibernation setting may be changed by the user, but are set automatically depending on the amount of usage. In addition to explicit configuration, ReflektOS may reference prior usage data and automatically adjust environmental response behavior accordingly.

ReflektOS and Reflektor's environmental response functions depend on provided hardware and may change in future software revisions or as a result of user modifications

### 3C: Privacy Features

ReflektOS features an extensive array of privacy features in order to benefit the user.

A system-wide passcode may be set and required before waking or powering on. This passcode is under an embodiment triggered either by the first-time setup or later through the Myra app. When set, this passcode may be activated by time, power cycle, manual activation, paired third-party device proximity, or by custom triggers. When activated, this passcode encrypts all user data on the device. Until the passcode is entered, none of the device information may be accessible to the app or user. ReflektOS may be configured to employ standard cryptographic measures to protect user data and system integrity; it may additionally be configured to require user authentication for certain features, such as the previously mentioned cryptographic protections.

User privacy is also taken into account when communicating with third party services. In order to send voice data over the internet, a user authorizes under one embodiment both internet communication and third-party software communication explicitly; these features are disabled until prompted otherwise. ReflektOS may be configured such that attempts to access potentially sensitive user information require explicit authorization.

Voice data is sent to Amazon AWS servers in raw format under an embodiment, and the voice data is transcribed and returned to Myra and the paired apps. Myra's microphones use API-based streaming to AWS cloud voice servers, which analyze the spoken noises and return a list of words. This data is then processed by ReflektOS. However, under one embodiment, no video data is sent through the internet, and default Facets do not have the ability to access the camera; only the app has this feature.

Additional privacy features may include biometrics and advanced parallel encryption.

### 3D: App

The Myra app is an app authored for third-party devices, utilized by a user to control all settings, Facets, and features of Myra. This app is developed for native execution on all major mobile platforms.

The app uses native APIs on all devices for network communication. Upon establishing a successful connection to the network server created by ReflektOS, the app recognizes a unique device signature to determine if Myra is being set up for the first time, or if a user profile of settings exist.

ReflektOS includes services for configuring and administrating the system remotely, whether over a wireless network or via some other connection. Of particular note are “companion” applications developed by On The Wall, Inc. which take advantage of these services. Companion applications may be developed for various third-party devices and platforms. These applications may be used for first-time setup of a ReflektOS device as well as for general device configuration and administration.

Upon reading a user profile, the Myra app loads a visual representation of the placement of the Facets of the Myra. Facets are placed on the virtual screen in respect to their real-time placement on the app, and vice versa. This simulated display is called a “virtual reflection.” Due to technical and imposed limitations, Facets are stored on Myra; however, data from the Facets can be optionally stored on a user's compatible third-party device.

One possible use of companion apps is Facet management. Companion applications may display a limited simulacrum of the ReflektOS graphical interface; this simulacrum may be used as a visual aid in configuring Facets or other device features. Other functions of companion applications may include, but are not limited to: direct configuration or manipulation of applications and system services; retrieval or modification of application and/or system data; and management of software installations.

### 3E: User Interface

ReflektOS support an array of different devices and input methods. To this end, it provides applications with mechanisms both for utilizing supported inputs that exist on the current device as well as for scaling for devices which do not support some inputs. For example, an application may be programmed to utilize touch screen support or voice commands, but would also be able to fall back and function inasmuch as possible on devices without these inputs.

Note that an embedded processor for running hardware/software processes of the systems and methods described herein comprise a Raspberry Pi 3 platform but embodiments are not so limited.

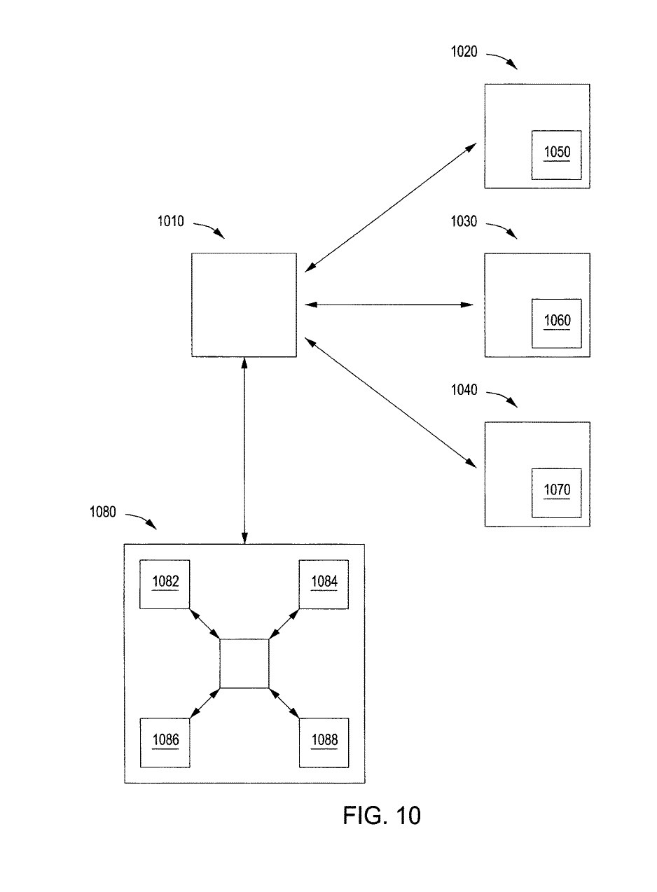

FIG. 10 shows the Myra device 1010 communicatively coupled with an Android™ device 1020 running an Android™ operating system, an Apple™ device 1030 running an iOS™ operating system, and/or a Windows™ device 1040 running a Windows™ operating system. The communicative coupling may comprise wired or wireless communications protocols. Each device may run a corresponding Myra mobile device application (1050, 1060, 1070). Wireless communications protocols may include Bluetooth™ or WiFi™ communications protocols. FIG. 10 also shows the Myra device wirelessly coupled with a wireless local area network 1080 which itself couples devices 1082, 1084, 1086, 1088.

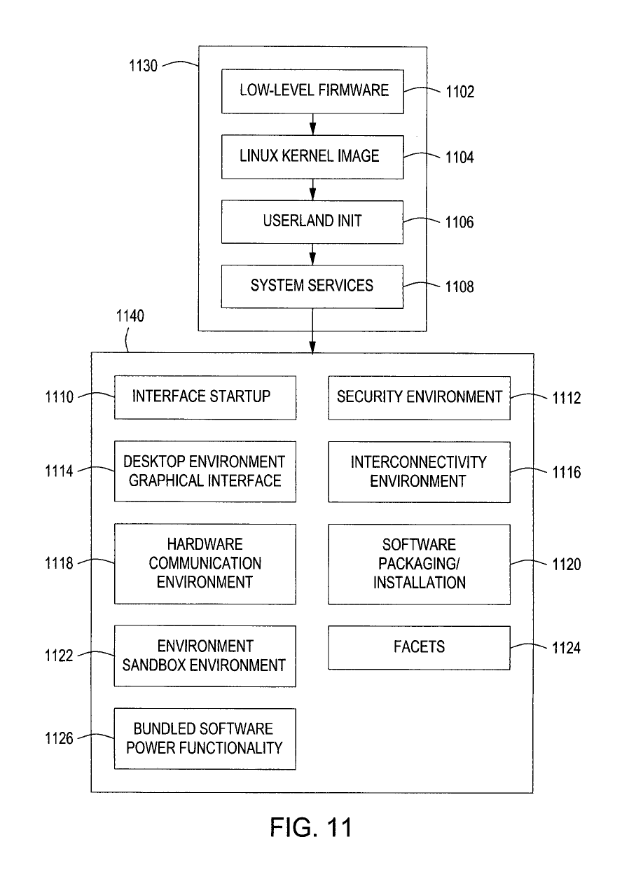

FIG. 11 shows a software specification of ReflektOS programs, components and environments in boot order 1130 (Low-Level Firmware 1102, Linux Kernel Image 1104, Userland Init 1106, and System Services 1108); and spatial order 1140 (Interface Startup 1110, Security Environment 1112, Graphical Interface 1114, Interconnectivity Environment 1116, Hardware Communication Environment 1118, Software Packaging/Installation Environment 1120, Sandbox Environment 1122, Facets 1124, Bundled Software 1126, Power Functionality 1128).

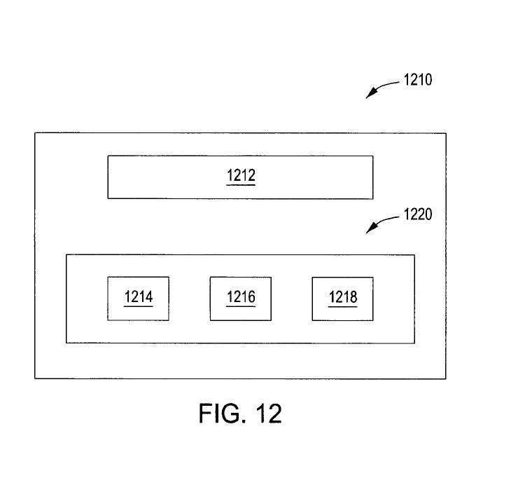

FIG. 12 shows a schematic representation of a ReflektOS operating system 1210, under an embodiment. The operating system includes a boot component 1212 for controlling low level firmware and boot processes, wherein the boot component loads an initialization process. The operating system includes a graphical interface 1214 for launching and displaying device applications. The operating system includes an authorization component 1216 for authorizing installation of the device applications, wherein the authorization component comprises an installation component for installing the device applications. The operating system includes a communications interface 1218 for establishing communications with a mobile application running on a processor of at least one mobile device. FIG. 12 shows the Reflektor application package 1220 under an embodiment.

An system is described under an embodiment that comprises an operating system including one or more applications running on computing hardware of a smart mirror device. The one or more applications provide a boot component for controlling low level firmware and boot processes, wherein the boot component loads an initialization process. The one or more applications provide a graphical interface for launching and displaying device applications. The one or more applications provide an authorization component for authorizing installation of the device applications, wherein the authorization component comprises an installation component for installing the device applications. The one or more applications provide a communications interface for establishing communications with a mobile application running on a processor of at least one mobile device.

The mobile application mirrors an appearance and functionality of the graphical interface on an interface of the mobile device, under an embodiment.

The low level firmware and boot processes comprise under an embodiment testing computer hardware component functionality including basic electrical functionality.

The low level firmware and boot processes comprise loading a kernel, under an embodiment.

The kernel runs the initialization process, under an embodiment.

The initialization process runs scripts to initialize system services and system software, under an embodiment.

The system services and system software comprise under an embodiment one or more of a WiFi™ stack, a Bluetooth™ stack, sound system stacks, and graphics stacks.

The initialization process comprises under an embodiment at least of one systemd and sysvinit.

The graphical interface displays under an embodiment the device applications, the displaying including placement and appearance of the device applications.

The graphical interface communicates under an embodiment with at least one of the system services and system software to launch device applications.

The launching includes under an embodiment receiving selection of a device application of the device applications through capacitive touch via a display screen of the smart mirror device or through selection via rotary switch of the smart mirror device.

The display screen comprises a two-way mirror stack adjacent an LCD display, under an embodiment.

The graphical interface communicates with at least one of system services and system software to manage a state of each device application, under an embodiment.

The establishing communications with the mobile application comprises under an embodiment the communications interface broadcasting a Bluetooth™ server.

The establishing communications with the mobile application comprises the communications interface broadcasting an IEEE802.11 Wi-Fi™ network, under an embodiment.

The establishing communications with a mobile application comprising the mobile application communicatively coupling with at least one of the Bluetooth™ server and WiFi™ network, under an embodiment.

The establishing the communications includes under an embodiment the one or more applications and the communication interface conforming with API specifications for audio and video communications with respect to third party operating systems running on external devices, wherein the third party operating systems include a Windows™ environment, Windows Mobile™ environment, an iOS™ environment, a MacOS™ environment, and a Linux™ environment.

The authorization component includes under an embodiment a certificate authority, wherein the authorization component uses certification authority digital certificates to approve device applications.

The one or more applications include under an embodiment an application package for a subset of the device applications.

The application package is under an embodiment installable and reusable in third party operating system environments, wherein the third party operating system environments comprise a Windows™ environment, a Windows Mobile™ environment, an iOS™ environment, a MacOS™ environment, and a Linux™ environment.

The application package includes under an embodiment a packaged graphical interface for launching and displaying a subset of the device applications.

The application package includes under an embodiment a packaged authorization and installation component for authorizing installation of a subset of the device applications.

The application package includes under an embodiment a packaged communications interface.

The operating system comprises under an embodiment a ReflektOS operating system, wherein the application package comprises Reflektor, wherein the subset of device applications comprises Facet applications.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one or more LANs, WANs, Internets, and computers. The computers may serve as servers, clients, or a combination thereof.

The systems, methods and apparatus for providing a smart mirror and corresponding operating system can be a component of a single system, multiple systems, and/or geographically separate systems. The systems, methods and apparatus for providing a smart mirror and corresponding operating system can also be a subcomponent or subsystem of a single system, multiple systems, and/or geographically separate systems. The components can be coupled to one or more other components (not shown) of a host system or a system coupled to the host system.

One or more components of the systems, methods and apparatus for providing a smart mirror and corresponding operating system and/or a corresponding interface, system or application to which the systems, methods and apparatus for providing a smart mirror and corresponding operating system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the systems, methods and apparatus for providing a smart mirror and corresponding operating system can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems, methods and apparatus for providing a smart mirror and corresponding operating system and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems, methods and apparatus for providing a smart mirror and corresponding operating system and corresponding systems and methods include: microcontrollers with memory (such as electronically erasable programmable read only memory (EEPROM)), embedded microprocessors, firmware, software, etc. Furthermore, aspects of the systems, methods and apparatus for providing a smart mirror and corresponding operating system and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems, methods and apparatus for providing a smart mirror and corresponding operating system and corresponding systems and methods is not intended to be exhaustive or to limit the systems and methods to the precise forms disclosed. While specific embodiments of, and examples for, the systems, methods and apparatus for providing a smart mirror and corresponding operating system and corresponding systems and methods are described herein for illustrative purposes, various equivalent modifications are possible within the scope of the systems and methods, as those skilled in the relevant art will recognize. The teachings of the systems, methods and apparatus for providing a smart mirror and corresponding operating system and corresponding systems and methods provided herein can be applied to other systems and methods, not only for the systems and methods described above.

The elements and acts of the various embodiments described above can be combined to provide further embodiments. These and other changes can be made to the systems, methods and apparatus for providing a smart mirror and corresponding operating system and corresponding systems and methods in light of the above detailed description.

What we claim is:

1. An system comprising,
an operating system comprising one or more applications running on computing hardware of a smart mirror device, the one or more applications providing,
a boot component for controlling low level firmware and boot processes, wherein the boot component loads an initialization process;
a graphical interface for launching and displaying device applications;
an authorization component for authorizing installation of the device applications, wherein the authorization component comprises an installation component for installing the device applications;
a communications interface for establishing communications with a mobile application running on a processor of at least one mobile device.

2. The system of claim 1, wherein the mobile application mirrors an appearance and functionality of the graphical interface on an interface of the mobile device.

3. The system of claim 1, wherein the low level firmware and boot processes comprise testing computer hardware component functionality including basic electrical functionality.

4. The system of claim 1, wherein the low level firmware and boot processes comprise loading a kernel.

5. The system of claim 4, wherein the kernel runs the initialization process.

6. The system of claim 5, wherein the initialization process runs scripts to initialize system services and system software.

7. The system of claim 6, wherein the system services and system software comprise one or more of a WiFi™ stack, a Bluetooth™ stack, sound system stacks, and graphics stacks.

8. The system of claim 6, wherein the initialization process comprises at least of one systemd and sysvinit.

9. The system of claim 7, wherein the graphical interface displays the device applications, the displaying including placement and appearance of the device applications.

10. The system of claim 9, wherein the graphical interface communicates with at least one of the system services and system software to launch device applications.

11. The system of claim 10, the launching including receiving selection of a device application of the device applications through capacitive touch via a display screen of the smart mirror device or through selection via rotary switch of the smart mirror device.

12. The system of claim 11, wherein the display screen comprises a two-way mirror stack adjacent an LCD display.

13. The system of claim 11, wherein the graphical interface communicates with at least one of system services and system software to manage a state of each device application.

14. The system of claim 7, wherein the establishing communications with the mobile application comprises the communications interface broadcasting a Bluetooth™ server.

15. The system of claim 14, wherein the establishing communications with the mobile application comprises the communications interface broadcasting an IEEE802.11 Wi-Fi™ network.

16. The system of claim 15, the establishing communications with a mobile application comprising the mobile application communicatively coupling with at least one of the Bluetooth™ server and WiFi™ network.

17. The system of claim 7, the establishing the communications including the one or more applications and the communication interface conforming with API specifications for audio and video communications with respect to third party operating systems running on external devices, wherein the third party operating systems include a Windows™ environment, Windows Mobile™ environment, an iOS™ environment, a MacOS™ environment, and a Linux™ environment.

18. The system of claim 7, wherein the authorization component includes a certificate authority, wherein the authorization component uses certification authority digital certificates to approve device applications.

19. The system of claim 7, wherein the one or more applications include an application package for a subset of the device applications.

20. The system of claim 19, wherein the application package is installable and reusable in third party operating system environments, wherein the third party operating system environments comprise a Windows™ environment, a Windows Mobile™ environment, an iOS™ environment, a MacOS™ environment, and a Linux™ environment.

21. The system of claim 20, wherein the application package includes a packaged graphical interface for launching and displaying a subset of the device applications.

22. The system of claim 20, wherein the application package includes a packaged authorization and installation component for authorizing installation of a subset of the device applications.

23. The system of claim 20, wherein the application package includes a packaged communications interface.

24. The system of claim 20, wherein the operating system comprises a ReflektOS operating system, wherein the application package comprises Reflektor, wherein the subset of device applications comprises Facet applications.
